(19) United States
(12) Patent Application Publication
(10) Pub. No.: US 2012/0125052 A1
(43) Pub. Date: May 24, 2012

(54) LOW-CARBON-TYPE IN-FLIGHT MELTING FURNACE UTILIZING COMBINATION OF PLASMA HEATING AND GAS COMBUSTION, MELTING METHOD UTILIZING THE SAME AND MELTING SYSTEM UTILIZING THE SAME

(75) Inventors: Sang Keun DONG, Daejeon (KR); Si Won KUM, Yongin (KR)

(73) Assignee: KOREA INSTITUTE OF ENERGY RESEARCH, Daejeon (KR)

(21) Appl. No.: 13/301,920

(22) Filed: Nov. 22, 2011

(30) Foreign Application Priority Data
Nov. 22, 2010 (KR) 10-2010-0116070

(51) Int. Cl. C03B 5/235; C03B 5/23; C04B 5/02; C03B 3/02

(52) U.S. Cl. 65/136.3; 65/335; 65/142; 65/143

(57) ABSTRACT

A low-carbon-type in-flight melting furnace for melting granular raw material for glass production in in-flight state using plasma heating and gas combustion, a melting method using the same and a melting system utilizing the same are provided. The low-carbon-type in-flight melting furnace includes a melting furnace body unit; a melting tank in the melting furnace body unit; a melting unit provided above the melting tank and serving to melt raw material; a raw material feeding unit provided outside the melting unit; a plasma/gas melting device provided around the melting unit and serving to spray high-temperature flames produced by plasma and gas; an exhaust tube provided at one side of the melting tank and serving to discharge exhaust gas; and a tap hole for tapping the melt, formed in the melting unit, through the melting tank, in the form of a slag.

### CROSS REFERENCE TO RELATED APPLICATION

This application claims the benefit under 35 U.S.C. 119(a) of Korean Patent Application No. 10-2010-0116070, filed on Nov. 22, 2010, the disclosure of which is incorporated by reference in its entirety for all purposes.

### BACKGROUND OF THE INVENTION

1. Field of the Invention

The present invention relates to a low-carbon-type in-flight melting furnace utilizing a combination of plasma heating and gas combustion, a melting method utilizing the same, and a melting system utilizing the same. Specifically, the present invention relates to a low-carbon-type in-flight melting furnace in which a granular raw material for glass production can be melted in an in-flight state using a combined technology of plasma heating and gas combustion, thus making desired glass compositions, including general-purpose glass and a frit for next-generation electronic devices, a method of melting using the low-carbon-type in-flight melting furnace and a melting system utilizing the low-carbon-type in-flight melting furnace.

2. Description of the Prior Art

In general, a melting furnace is used to melt a solid material by heating it to its melting point or higher. Glass melting technology which is currently widely used worldwide utilizes tank furnaces which are the so-called Siemens-type furnaces. Such Siemens-type furnaces are divided into various categories according to their intended use or melting capacity. Siemens-type glass melting technology comprises heating a raw material for glass production by radiation from the burner flame, recovering waste heat by a regenerative furnace, and preheating combustion air using the regenerated energy as a substitute for the burner, thereby increasing heat efficiency.

Meanwhile, most of the energy that is consumed during the process of melting in the conventional Siemens-type furnaces compensates for the loss of heat to the furnace wall or the outside so as to maintain the material of the large furnace at high temperatures. Thus, energy that is used to melt a glass raw is about 20-30%. Accordingly, for energy saving during glass production, not only the process for melting of the raw material of glass, but also the melting technology need to be reviewed.

The average residence time of the glass melt in the melting tank of the conventional Siemens-type furnace is as long as about 1.5 days to 7 days. For this reason, there is a need to shorten the residence time of the glass melt, thus making it possible to achieve energy reduction goals while maintaining high quality.

In addition, in the conventional melting furnaces, there is a problem in that the easily melting components (soda materials) and slowly melting components (silica materials) of the particulate raw material are solidified together while they are likely to form a heterogeneous melt.

### SUMMARY OF THE INVENTION

Accordingly, the present invention has been made in view of the problems occurring in the prior art, and it is an object of the present invention to provide a low-carbon-type in-flight melting furnace in which a granular raw material for glass production can be melted in an in-flight state using a combined technology of plasma heating and gas combustion, thus making desired glass compositions, including general-purpose glass and a frit for next-generation electronic devices, a method of melting using the low-carbon-type in-flight melting furnace and a melting system utilizing the low-carbon-type in-flight melting furnace.

In one aspect, the present invention provides a low-carbon-type in-flight melting furnace comprising: a melting furnace body unit; a melting tank provided in the melting furnace body unit; a melting unit provided above the melting tank and serving to melt a raw material; a raw material feeding unit provided at the outside of the melting unit; a plasma/gas melting device provided around the melting unit and serving to spray high-temperature flames produced by plasma and gas; an exhaust tube provided at one side of the melting tank and serving to discharge exhaust gas; and a tap hole for tapping the melt, formed in the melting unit, through the melting tank in the form of a slag.

The in-flight melting furnace may further comprise an additional fuel/gas supply unit at one side of the melting unit in order to increase the temperature of the flames generated from the plasma/gas melting device. Also, an additional gas supply tube may further be provided at the circumference of the plasma/gas melting device.

The raw material is a low-melting-point raw material prepared by processing and heating particulate raw materials for glass production, and the raw material may be uniformly melted in an in-flight state in the melting unit by the high-temperature combined flames produced by plasma and gas.

The gas may be air or oxygen.

The raw material is introduced into the melting unit in a state in which the high-temperature combined flames produced by plasma and gas are sprayed, whereby the raw material may be instantaneously melted.

The flames produced by plasma and gas may be a combination of a flame of about 10,000° C. resulting from plasma heating and a flame of about 2,000° C. resulting from gas combustion, and the in-flight temperature of the raw material in the melting unit may be 2000-3000° C.

The combined flames produced by plasma and gas may form a swirling flow in the melting unit, thereby maximizing the residence time of the raw material melt in the melting unit.

In another aspect, the present invention provides a method of melting utilizing a low-carbon-type in-flight melting furnace, the method comprising the steps of: producing high-temperature combined flames by plasma and gas in a plasma/gas melting device and spraying the produced high-temperature combined flames into a melting unit so as to form a swirling pattern; introducing a raw material into the melting unit having the high-temperature combined flames; instantaneously melting in an in-flight state by the high-temperature combined flames; and tapping the melt of the raw material in the form of a slag.

The method of the present invention may further comprise a step of operating an additional fuel/gas supply unit in order to increase the temperature of the flames produced by plasma and gas in the step of spraying the flames.

In the method of the present invention, the raw material is a low-melting-point raw material prepared by processing and heating particulate raw materials for glass production, and the raw material may be uniformly melted in an in-flight state in the melting unit by the high-temperature combined flames produced by plasma and gas.

The gas may be air or oxygen, and the flames produced by plasma and gas may be a combination of a flame of about 10,000° C. resulting from plasma heating and a flame of about 2,000° C. resulting from gas combustion, and the in-flight temperature of the raw material in the melting unit may be 2000-3000° C.

The combined flames produced by plasma and gas may form a swirling flow in the melting unit, thereby maximizing the residence time of the raw material melt in the melting unit.

In still another aspect, the present invention provides a melting system utilizing a low-carbon-type in-flight melting furnace, the melting system comprising: a pretreatment step of processing and heating particulate raw materials for glass production to prepare a granular, low-melting-point raw material; an in-flight melting step of melting the granular, low-melting-point raw material in the in-flight melting furnace and tapping the melt of the raw material in the form of a slag; a post-treatment step of crushing/milling the tapped melt; and a product production step of producing a final product from the material resulting from the post-treatment step.

The granular, low-melting-point raw material that is prepared in the pretreatment step may be prepared by press-processing the particulate raw materials for glass production to prepare a panel-type material and heating the panel-type material while passing it through a calcining furnace. In the in-flight melting step, the granular, low-melting-point raw material is introduced into the in-flight furnace in a state in which high-temperature combined flames produced by plasma and gas in the plasma/gas melting device are sprayed into the melting unit so as to form a swirling pattern; and the introduced low-melting-point raw material is instantaneously uniformly melted in an in-flight state by the combined flames produced by plasma and gas.

The gas may be air or oxygen. The flames produced by plasma and gas may be a combination of a flame of about 10,000° C. resulting from plasma heating and a flame of about 2,000° C. resulting from gas combustion, and the in-flight. temperature of the raw material in the melting unit may be 2000-3000° C. The combined flames produced by plasma and gas may form a swirling flow in the melting unit, thereby maximizing the residence time of the raw material melt in the melting unit.

The post-treatment step may be carried out by cooling, pinching and crushing/milling the tapped melt using rollers, and the material production step may be carried out by blending the material resulting from the post-treatment step with other materials to produce a final product which is used to prepare a glass frit, a glass frit for electronic devices, or a ceramic frit.

### BRIEF DESCRIPTION OF THE DRAWINGS

The above and other objects, features and advantages of the present invention will be more clearly understood from the following detailed description taken in conjunction with the accompanying drawing, in which:

FIG. 1 is a conceptual view of a low-carbon-type in-flight melting furnace utilizing a combination of plasma heating and gas combustion according to one embodiment of the present invention;

FIG. 2 illustrates the structure and principle of a low-carbon-type in-flight melting furnace utilizing a combination of plasma heating and gas combustion according to one embodiment of the present invention;

FIG. 3 is a schematic view of a low-carbon-type in-flight melting furnace utilizing a combination of plasma heating and gas combustion according to one embodiment of the present invention;

FIG. 4 is a flow chart showing a melting method utilizing a combination of plasma heating and gas combustion according to one embodiment of the present invention;

FIG. 5 is an overall process view showing a melting system utilizing a combination of plasma heating and gas combustion according to one embodiment of the present invention, wherein the melting system comprises (a) a pretreatment step, (b) an in-flight melting step, (c) a post-treatment step, and (d) a product production step; and

FIG. 6 is a flow chart of a melting system utilizing a combination of plasma heating and gas combustion according to one embodiment of the present invention.

### DETAILED DESCRIPTION OF THE INVENTION

The foregoing and other objects, features and advantages of the present invention will become more apparent from the following description of embodiments with reference to the accompanying drawings. Hereinafter, specific embodiments of the present invention will be described in detail with reference to the accompanying drawings, in which like reference numerals indicate like elements.

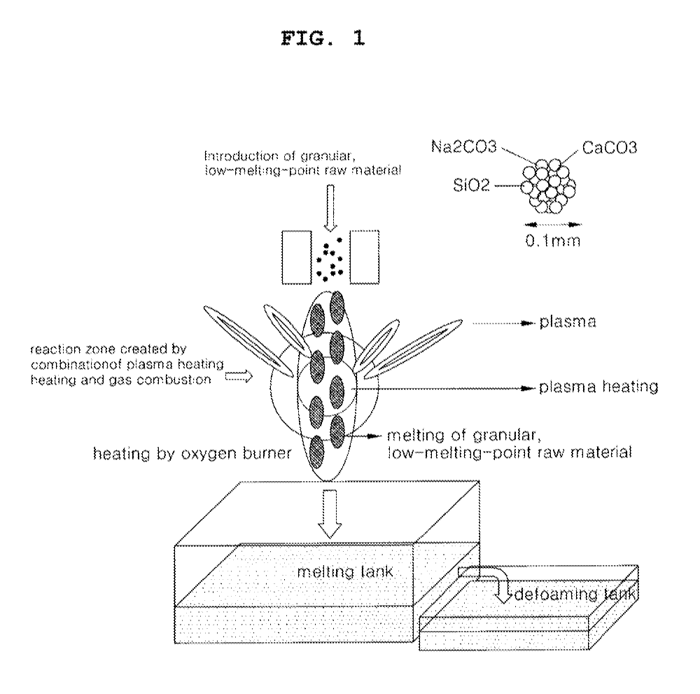

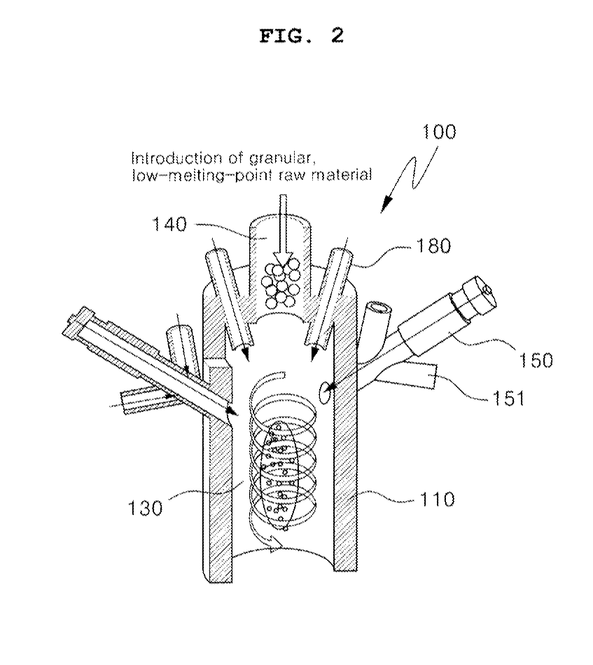

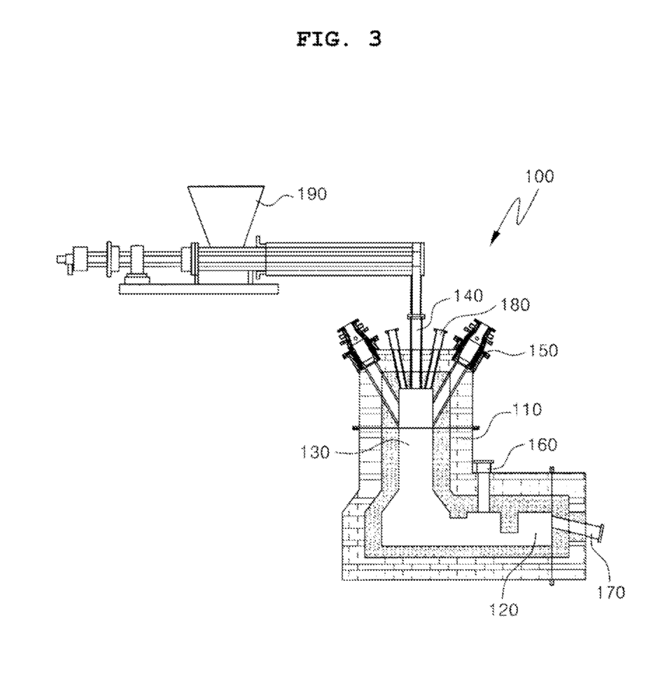

FIG. 1 is a conceptual view of a low-carbon-type in-flight melting furnace utilizing a combination of plasma heating and gas combustion according to one embodiment of the present invention; FIG. 2 illustrates the structure and principle of a low-carbon-type in-flight melting furnace utilizing a combination of plasma heating and gas combustion according to one embodiment of the present invention; and FIG. 3 is a schematic view of a low-carbon-type in-flight melting furnace utilizing a combination of plasma heating and gas combustion according to one embodiment of the present invention.

As shown in FIG. 1, in-flight melting technology utilizing a combination of plasma heating and gas (oxygen) combustion according to the present invention is a technology in which a granular, low-melting-point raw material prepared by granulating a particulate raw material for glass production (that is, granulated by a crystallization process) is passed through a reaction zone created by a combination of plasma heating and gas combustion while it is made into glass. Herein, the melting time is the in-flight time (within 1 second) of the raw material introduced, whereby the volume of the melting tank can be significantly reduced. In the present invention, in order to promote uniform melting, granules of each of granular batches prepared by granulating the particulate raw materials of glass provides an optimal glass composition when they are melted. Accordingly, unlike the prior art, a high-temperature melt does not need to be maintained in a large melting tank for a long time, thus making it possible to reduce energy consumption. Also, in the conventional melting furnace, the easily melting components (soda materials) and slowly melting components (silica materials) of the particulate raw material are solidified together while they are likely to form a heterogeneous melt, whereas, in the high-temperature in-flight melting method according to the present invention, the granules are uniformly melted while they are made into glass.

As shown in FIGS. 1 to 3, a low-carbon-type in-flight melting furnace 100 according to one embodiment of the present invention comprises a melting furnace body unit 110, a melting tank 120, a melting unit 130, a raw material feeding unit 140, a plasma/gas melting device 150, an exhaust tube 160 and a tap hole 170.

The melting tank 120 is formed in the body unit 110 and serves to collect the melt. The melting unit 130 is provided above the melting tank 120 and serves to melt the raw material, that is, the granular, low-melting-point raw material. The plasma/gas melting device 150 is provided around the melting unit 130 and serves to supply high-temperature flames produced by plasma and gas. The gas is preferably oxygen which is burned by an oxygen burner, but it may also be air.

Herein, the granular, low-melting-point raw material is supplied through the raw material feeding unit 140 formed at the outside of the melding unit 30. Also, the granular, low-melting-point raw material is prepared by processing and heating a particulate raw material for glass production and is introduced into the melting unit 130 through a raw material hopper 190 and the raw material feeding unit 140. As the granular, low-melting-point raw material is introduced into the melting unit 130 as described above, it is melted in an in-flight state in the melting unit 130 by high-temperature combined flames produced by plasma and gas. Specifically, the granular, low-melting-point raw material is introduced into the melting unit 130 in a state in which high-temperature combined flames produced by plasma and gas are sprayed into the melting unit, whereby the raw material is instantaneously melted. Herein, the flames produced by plasma and gas are a combination of a flame of 10,000° C. resulting from plasma heating and a flame of 2,000° C. resulting from oxygen combustion, and the in-flight temperature of die raw material in the melting unit may be 2000-3000° C. Meanwhile, the particulate raw material for glass production may include SiO₂, Al₂O₃, NaCO₃, CaCO₃, BaO₃ and the like.

As shown in FIG. 2, the combined flames produced by plasma and gas can form a swirl flow in the melting unit 130, thereby maximizing the residence time of the raw-material melt in the melting unit 130. This can promote the melting of the raw material.

As shown in FIGS. 2 and 3, the in-flight melting furnace further comprises an additional fuel/gas supply unit at one side of the melting unit in order to further increase the temperature of the flames generated from the plasma/gas melting device 150. Also, the exhaust gas 160 is provided at one side of the melting tank 120 and serves to discharge exhaust gas during the melting caused by the combined flames resulting from plasma heating and oxygen combustion. The melt formed in the melting unit 130 is tapped in the form of a slag from the melting tank 120 through the tap hole 170.

The plasma/gas melting device 150 used in this embodiment comprises: a plasma torch provided such that, when electric power is applied to a coil wound around an electrode assembly, a magnetic field can be formed in a reaction space within the electrode assembly so that plasma produced during electric discharge can be influenced by the magnetic field to maintain a swirling pattern; and a combustion nozzle which extends from the outlet of the torch and serves to mix air with fuel gas to produce a flame having a temperature suitable for treating a material. The plasma/gas melting device 150 is similar to a plasma/gas combustion device disclosed in Korean Patent Laid-Open Publication No. 2010-0026707 filed in the name of the applicant, and thus the detailed description thereof is omitted herein. Also, a gas supply tube 151 is further provided at the circumference of the plasma/gas melting device 150, such that the temperature of the flames generated from the plasma/gas melting device 150 can further be increased.

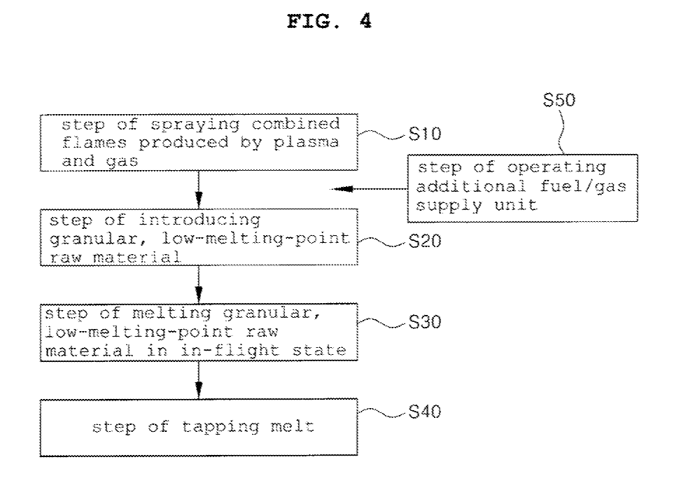

Hereinafter, a method of melting according to one embodiment of the present invention, which is carried out using the in-flight melting furnace having the above-described configuration, will be described. FIG. 4 is a flow chart showing a method of melting utilizing an in-flight melting furnace according to one embodiment of the present invention.

As shown in FIG. 4, the melting method utilizing the low-carbon-type in-flight melting furnace according to one embodiment of the present invention comprises the steps of: (S10) producing high-temperature combined flames by plasma and gas in the plasma/gas melting device and spraying the produced flames into the melting unit so as to form a swirling flow; (S20) introducing a granular, low-melting-point raw material, prepared by processing and heating a particulate raw material for glass production, into the melting unit having the high-temperature combined flames; (S30) instantaneously uniformly melting the raw material in an in-flight state by the high-temperature combined flames; and (S40) tapping the melt in the form of a slag. Meanwhile, the melting method according to this embodiment may further comprise a step (S50) of operating an additional fuel/gas supply unit in order to increase the temperature of the flames produced by plasma and gas in step (S10).

Hereinafter, the in-flight melting technology according to the present invention will compare with the prior art technology while the difference therebetween will be described.

In the melting technology according to the prior art, the raw material is melted for a long time, and thus, the easily melting components (soda-based materials) and slowly melting components (silica-based materials) of the raw material are solidified together while they are likely to form a heterogeneous melt. Also, because the raw material is melted for a long time, a large amount of carbon oxide is generated. Unlike this, in the in-flight melting technology according to the present invention, the raw material can be instantaneously uniformly melted in an in-flight state by combined flames produced by plasma heating and gas combustion, whereby the generation of carbon dioxide can be reduced and energy reduction goals can be achieved.

Also, in the conventional melting furnace (e.g., the Siemens-type melting furnace), most of the energy that is consumed during the melting process compensates for the loss of heat to the furnace wall or the outside to maintain the material of the large furnace at high temperatures, and thus energy that is used to melt the raw material of glass is about 20-30%. For this reason, in the conventional melting furnace, the melting tank should have a large size, and a high-temperature melt should be maintained in the melting tank (e.g., about 1.5-7 days) in order to achieve desired quality, thus increasing energy consumption. Unlike this, in the in-flight melting technology according to the present invention, the raw material can be instantaneously melted in an in-flight state so that it can be completely melted within a few hours. Accordingly, the size of the melting tank can be significantly reduced, thus achieving energy reduction goals and reducing equipment investment costs. Specifically, according to the in-flight melting technology of the present invention, the melting time and the size of the melting tank can be reduced by about 50%, and energy consumption can also be reduced by about 50%.

Also, the in-flight melting technology according to the present invention makes it possible to produce a frit for electronic devices. Currently, frits for electronic devices have gradually decreasing melting points and are melted using an electric heater as a heat source. In the prior art method, a protective layer (Si-based layer) is formed on the low-melting glass frit to provide corrosion resistance, but the S-based protective layer is also melted during melting of the low-melting-point material, thus shortening the life expectancy of the electric heater. However, in the in-flight melting furnace according to the present invention, the granular, low-melting-point raw material can be melted in an in-flight state by a plasma heat source, and thus the melting furnace of the present invention can also be applied to produce a frit for electronic devices. In addition, the electric heater method according to the prior art is an indirect heating method, but the in-flight melting technology according to the present invention is a direct heating method, and thus can achieve energy reduction goals.

Also, the in-flight melting technology according to the present invention makes it possible to produce small amounts of a variety of ceramic materials. In order to produce ceramic materials, large-scale production equipment was required in the prior art, thus making it difficult to small amounts of a variety of ceramic materials. However, the in-flight melting furnace according to the present invention can be miniaturized as described above, and thus can produce required amounts of various ceramic materials.

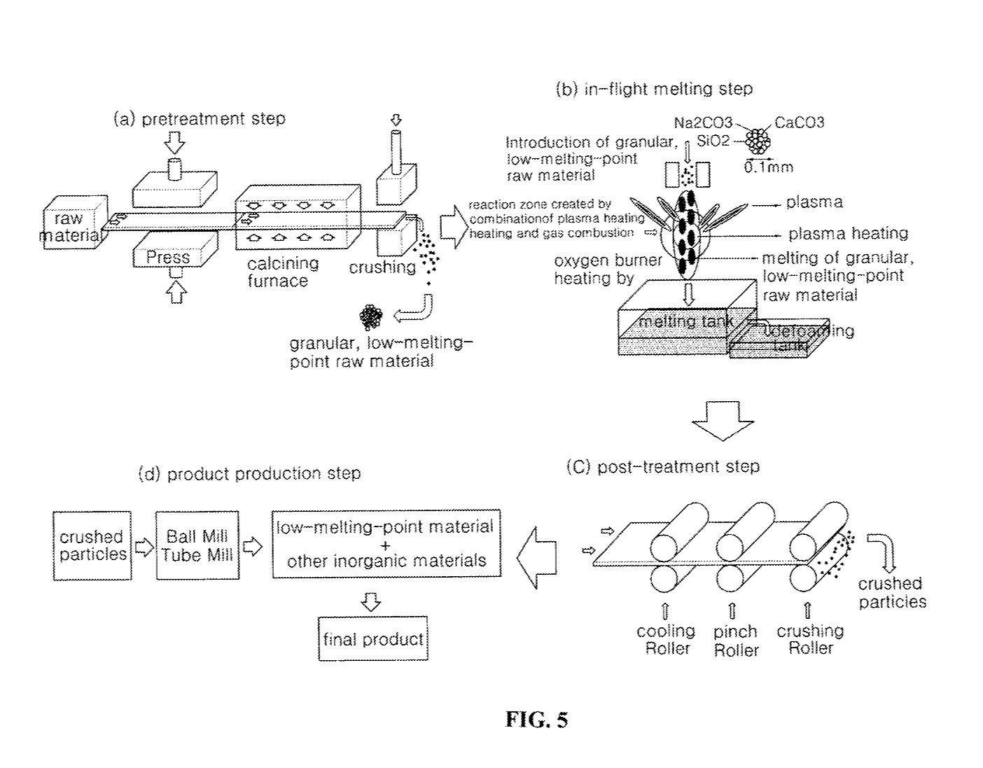

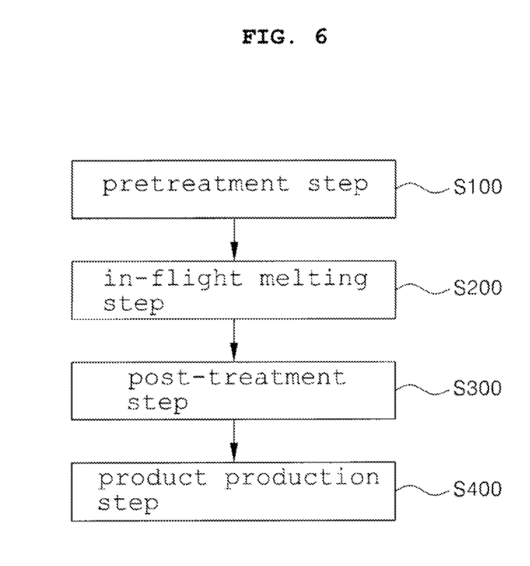

Hereinafter, a melting system utilizing an in-flight melting furnace according to one embodiment of the present invention will be described. FIG. 5 is an overall process diagram showing a melting system utilizing an in-flight melting furnace according to one embodiment of the present invention. The melting system shown in FIG. 5 comprises: (a) a pretreatment step; (b) an in-flight melting step; (c) a post-treatment step; and (d) a material preparation step. FIG. 6 is a flow chart of a melting system utilizing an in-flight melting furnace according to one embodiment of the present invention.

As shown in FIGS. 5 and 6, the melting system utilizing the low-carbon-type in-flight melting furnace according to the present invention comprises: a pretreatment step of processing and heating a particulate raw material for glass production to prepare a granular, low-melting-point raw material ((a) of FIGS. 5 and S100 of FIG. 6); an in-flight melting step of melting the granular, low-melting-point raw material in the in-flight melting furnace and tapping the melt in the form of a slag ((b) of FIGS. 5 and S200 of FIG. 6); a post-treatment step of crushing/milling the tapped melt ((c) of FIGS. 5 and 5300 of FIG. 6); and a product production step of producing a final product from the material resulting from the post-treatment step ((d) of FIGS. 5 and S400 of FIG. 6).

As shown in FIG. 5(a), the granular, low-melting-point raw material which is prepared in the pretreatment step (S100) is prepared by press-processing particulate raw materials for glass production, including SiO₂, Al₂O₃, NaCO₃, CaCO₃, BaO₃ and the like, to prepare a panel-type material, and heating the panel-type material while passing it through a calcining furnace.

As shown in FIG. 5(b), in the in-flight melting step (S200), the granular, low-melting-point raw material is introduced into the in-flight furnace in a state in which high-temperature combined flames produced by plasma and gas (oxygen) in the plasma/gas melting device are sprayed into the melting unit so as to form a swirling pattern. The introduced low-melting-point raw material is instantaneously uniformly melted in an in-flight state by the combined flames produced by plasma and gas. The in-flight melting step has been described in the above section relating to the in-flight melting furnace and the method of melting using the same, and thus the detailed description thereof will be omitted below.

As shown in FIG. 5(c), in the post-treatment step (S300), the melt tapped in the slag form in the in-flight melting step is rolled, pinched and crushed/milled by rollers. As shown in FIG. 5(d), in the material production step (S400), the material resulting from the post-treatment step is blended with other materials (e.g., inorganic materials) to produce a final product which is used to produce a glass frit, a glass frit for electronic devices, or a ceramic frit.

As described above, according to the present invention, granular raw materials for glass production can be melted in an in-flight state using a combination of a flame resulting from plasma heating and a flame resulting from gas combustion. Thus, the present invention makes it possible to prepare not only general-purpose glass, but also a frit for next-generation electronic devices, and a glass composition comprising ceramic materials.

Moreover, according to the present invention, the generation of carbon dioxide can be reduced, and the volume of melting and the melting time can be reduced, thus achieving energy reduction goals.

In addition, according to the present invention, the melting furnace can be miniaturized, thus making it possible to produce small amounts of a variety of materials.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A low-carbon-type in-flight melting furnace comprising:
a melting furnace body unit;
a melting tank provided in the melting furnace body unit;
a melting unit provided above the melting tank and serving to melt a raw material;
a raw material feeding unit provided at the outside of the melting unit;
a plasma/gas melting device provided around the melting unit and serving to spray high-temperature flames produced by plasma and gas;
an exhaust tube provided at one side of the melting tank and serving to discharge exhaust gas; and
a tap hole for tapping the melt, formed in the melting unit, through the melting tank in the form of a slag.

2. The low-carbon-type in-flight melting furnace of claim 1, wherein the in-flight melting furnace further comprises an additional fuel/gas supply unit at one side of the melting unit in order to increase the temperature of the flames generated from the plasma/gas melting device, and an additional gas supply tube is further provided at the circumference of the plasma/gas melting device.

3. The low-carbon-type in-flight melting furnace of claim 1, wherein the raw material is a low-melting-point raw material prepared by processing and heating particulate raw materials for glass production, and the raw material is uniformly melted in an in-flight state in the melting unit by the high-temperature combined flames produced by plasma and gas.

4. The low-carbon-type in-flight melting furnace of claim 1, wherein the gas is air or oxygen.

5. The low-carbon-type in-flight melting furnace of claim 1, wherein the raw material is introduced into the melting unit in a state in which the high-temperature combined flames produced by plasma and gas are sprayed, whereby the raw material is instantaneously melted.

6. The low-carbon-type in-flight melting furnace of claim 1, wherein the flames produced by plasma and gas are a combination of a flame of about 10,000° C. resulting from plasma heating and a flame of about 2,000° C. resulting from gas combustion, and the in-flight temperature of the raw material in the melting unit may be 2000-3000° C.

7. The low-carbon-type in-flight melting furnace of claim 1, wherein the combined flames produced by plasma and gas form a swirling flow in the melting unit, thereby maximizing the residence time of the melt of the raw material in the melting unit.

8. A melting method utilizing a low-carbon-type in-flight melting furnace, the method comprising the steps of:
producing high-temperature combined flames by plasma and gas in a plasma/gas melting device and spraying the produced high-temperature combined flames into a melting unit so as to form a swirling pattern;
introducing a raw material into the melting unit having the high-temperature combined flames;
instantaneously melting in an in-flight state by the high-temperature combined flames; and
tapping the melt of the raw material in the form of a slag.

9. The melting method of claim 8, wherein the method further comprises a step of operating an additional fuel/gas supply unit in order to increase the temperature of the flames produced by plasma and gas in the step of spraying the flames.

10. The melting method of claim 8, wherein the raw material is a low-melting-point raw material prepared by processing and heating particulate raw materials for glass production, and the raw material is uniformly melted in an in-flight state in the melting unit by the high-temperature combined flames produced by plasma and gas.

11. The melting method of claim 8, wherein the gas is air or oxygen, and the flames produced by plasma and gas are a combination of a flame of about 10,000° C. resulting from plasma heating and a flame of about 2,000° C. resulting from gas combustion, and the in-flight temperature of the raw material in the melting unit may be 2000-3000° C.

12. The method of claim 8, wherein the combined flames produced by plasma and gas form a swirling flow in the melting unit, thereby maximizing the residence time of the raw material melt in the melting unit.

13. A melting system utilizing a low-carbon-type in-flight melting furnace, the melting system comprising:
a pretreatment step of processing and heating particulate raw materials for glass production to prepare a granular, low-melting-point raw material;
an in-flight melting step of melting the granular, low-melting-point raw material in the in-flight melting furnace and tapping the melt of the raw material in the form of a slag;
a post-treatment step of crushing/milling the tapped melt; and
a product production step of producing a final product from the material resulting from the post-treatment step.

14. The melting system of claim 13, wherein the granular, low-melting-point raw material that is prepared in the pretreatment step is prepared by press-processing the particulate raw materials for glass production to prepare a panel-type material and heating the panel-type material while passing it through a calcining furnace.

15. The melting system of claim 13, wherein, in the in-flight melting step, the granular, low-melting-point raw material is introduced into the in-flight furnace in a state in which high-temperature combined flames produced by plasma and gas in the plasma/gas melting device are sprayed into the melting unit so as to form a swirling pattern; and the introduced low-melting-point raw material is instantaneously uniformly melted in an in-flight state by the combined flames produced by plasma and gas.

16. The melting system of claim 15, wherein the gas is air or oxygen, the flames produced by plasma and gas are a combination of a flame of about 10,000° C. resulting from plasma heating and a flame of about 2,000° C. resulting from gas combustion, the in-flight temperature of the raw material in the melting unit may be 2000-3000° C., and the combined flames produced by plasma and gas form a swirling flow in the melting unit, thereby maximizing the residence time of the raw material melt in the melting unit.

17. The melting system of claim 13, wherein the post-treatment step is carried out by cooling, pinching and crushing/milling the tapped melt using rollers, and the material production step is carried out by blending the material resulting from the post-treatment step with other materials to produce a final product which is used to prepare a glass frit, a glass frit for electronic devices, or a ceramic frit.
